(19) United States
(12) Patent Application Publication
(10) Pub. No.: US 2017/0147161 A1
(43) Pub. Date: May 25, 2017

(54) Dynamic Table of Contents of Media

(71) Applicant: Nomad Technologies, Inc., Eden Prairie, MN (US)

(72) Inventors: Brad White, Chaska, MN (US); Timothy Allen Kranzler, Eden Prairie, MN (US); Tom Erickson, St. Paul, MN (US)

(73) Assignee: Nomad Technologies, Inc., Eden Prairie, MN (US)

(21) Appl. No.: 14/950,562

(22) Filed: Nov. 24, 2015

(51) Int. Cl. G06F 3/0482; H04L 12/911; G06K 7/10; G06F 3/0484; G06F 17/30; G06Q 10/10; H04L 29/08; G06K 7/14

(52) U.S. Cl. CPC G06F 3/0482; H04L 67/02; H04L 47/70; H04L 67/10; G06K 7/1417; G06F 3/04842; G06F 17/3056; G06K 7/1413; G06Q 10/10; G06K 7/10861; G06F 17/30038; G06F 17/30058

(57) ABSTRACT

The invention relates to a system and method for providing a dynamic table of contents in a treeview control of a browser, each table of contents item associated with a piece of multi-media content. The dynamic table of contents is customized for all of the installed options of a particular serial number of a particular product to provide customized product documentation for all the various components of the end user's particular product.

### FIELD OF THE INVENTION

The invention relates to a system and method for providing a dynamic table of contents in a treeview control of a browser, each table of contents item associated with a piece of multi-media content. The dynamic table of contents is customized for all of the installed options of a particular serial number of a particular product to provide customized product documentation for all the various components of the end user's particular product.

### BACKGROUND OF THE INVENTION

Applicant revolutionizes the “the user/assembly manual”.

Imagine . . . A consumer purchases a lawn mower from their local lawn and garden store.

A large cardboard box containing the new lawn mower is loaded into the back of the consumer's vehicle. At home, the box is unloaded in the garage to prepare for assembly. The consumer takes out their mobile device (Phone, Ipad, notebook computer and so on) and scans the QR code (see FIG. 41) on the side of the box. A webpage (see example in FIG. 42) from the manufacturer appears on the mobile device. The branded webpage contains information about the manufacturer, their website, the serial number of the lawn mower inside the box and most importantly, a dynamically created table of contents specifically addressing the configuration of the lawn mower they just purchased. Based on the QR code, it can bring up a specific documentation type (i.e. Assembly Guide) and/or the user can also pick the type from a drop down list. Initially, the table of contents simply explains how to properly cut, open the box and remove the contents.

With the contents removed, the consumer scans another QR code on a bag full of smaller parts. The table of contents then changes to provide step by step assembly instructions in video form, narrated and annotated (potentially in the language of your choice) with animations, graphics and other visual effects applied so that anyone can easily understand how to proceed. With assembly complete, the consumer then scans the QR code on the lawn mower itself which changes the table of contents to the user manual where safety, operational and on-going maintenance is available at all times to the user. The configuration specific video user manual will always be instantly available to the consumer the next time they need to change oil, make an adjustment or learn a new feature. There might even be a QR code next to the dip stick that immediately provides the video step by step directions on how to change the oil of that device. Unlike paper manuals or those supplied on a CD/DVD, this manual is accessible anywhere the internet is and is updated in real time so the user is always getting the most up to date safety information to reduce risk and liability as well as the most current instructions on the operation and maintenance of their new lawn mower.

The scenario outlined above establishes the foundation for the Five Truths of Training.

### Five Truths of Training

TRUTH 1: When do people want to learn about a topic? Answer: People want to learn the information NOW or maybe better stated at the time of their need. Thus, having video training information available through the internet provides the most convenience and accessibility possible versus “Where in the world did I put that user manual?”
TRUTH 2: Are people becoming more inclined to read instruction manuals or watch how-to videos? Answer: Most people want to watch how to videos vs. read. The dramatic growth in “how to” youtube searches more than suggests that most people prefer to watch videos and listen to someone explain how to do something vs. trying to figure it out based on reading a static user manual.
TRUTH 3: We all wish that a user manual provided information exclusively on the configuration of the product and options we own versus all what might be possible for that product. For example, when you pull the thick printed user manual out of the glove box of your automobile, it talks about every engine, every transmission, every audio system and other various options available for that model . . . much of which have nothing to do with the vehicle you own. This is the real core of the AccuCourse invention.
TRUTH 4: Although it is highly advised to do so, most people do not want to read the whole manual or at least not more than once. So, in most circumstances, people only want to learn about the specific topic that they are interested in at the moment. So a table of contents, that lets you easily find and learn about the topic of choice is critical.
TRUTH 5: People want the information they learn to be accurate and up to date. Manufacturers particularly want safety information to be up to date to improve safety and reduce liability.

### Why are Configuration Specific User Manuals or Similar Content not Widely Available Today?

So if all of this rings true, why is it that this type of configuration specific video content is not currently offered and a standard for all complex products? The answer is related to the “Four Inherent Challenges of Linear Video” and the “Exponential Factor”.

### Four Inherent Challenges of Linear Video

Most videos today are constructed in a linear or “single-thread” method. By linear video, we mean one that is a single file. Press play and the video starts at the beginning and plays through to the end. Some viewing applications allow timelines to be defined within the linear video. These timelines can allow for chapter starting points or for the video to be perused with a slider bar. Such features can provide users with some flexibility as to what section is being viewed. Regardless of the methodology, the video is still dependent on the linear/single thread video structure. If you have a single, simple, static product with few or no variables, linear video can be an effective tool to provide online video user manuals. But if your product changes over time, has multiple models, options or other variables, the shortcomings of the traditional linear video methodology are quickly magnified.

Four of the most serious challenges inherent in linear video are obsolescence, redundancy, prioritization and practicality.

Obsolescence—One of the biggest complaints about video production is that it is no more than published in its final form, when it becomes obsolete and a new one has to be or should be created. Obsolescence can occur for a variety of reasons including; new or modified features, improved ordering, new safety instructions, new product names/numbers and so on. The original video or videos will need to be modified. Then you deal with existing users who may already possess the obsolete versions. Was the video online? How do you deal with old one? Publish new DVDs? Liability issues? The bigger your video library is, the bigger the issue of obsolescence becomes.

Redundancy/confusion—As a video producer tries to encompass more models or features into a single video, they are confronted with the potential need for repetitious content. Before you do this, you must do that. But, if you have this version, then you do this instead. If you repeat needed steps, the video can be long and boring. If you don't, users can become confused. It is a losing battle that typically leads to the next shortcoming.

Prioritization—As the videos gets longer and longer, the creator may start to remove less used features or operations to keep down the video length. Although less used, these features may still be very important to the users who have them . . . . Yet, those details are left out for brevity.

Practicality—As the next section clearly demonstrates, as you try to provide videos with specific content to what a user has in terms of models, options or other variables, linear video production is simply not practical. This is the single biggest reason why configuration specific content as outlined in the third truth of training is not a reality without AccuCourse.

### The Exponential Factor

You know exponents. 2³=2×2×2=8

The exponential factor as described here has to do with variables of a product and how many videos would be needed to teach someone the functionality of a product based on the specific configuration that the consumer owned.

Here is a real life example. An audio visual company named Nomad Technologies has four models. Within each of the four models, you can choose from three different styles of control touch panels, on the touch panels, icons can vary so that there are 20 different versions and so on. For each variation or option, you have to multiply by the previous total to see how many video versions you would need to create to provide configuration specific content based on what the consumer purchased/owned.

The calculation in FIG. 43 is a simplification to dramatize the exponential effect. The actual number of videos required may be subject to other dependencies that increase or decrease the actual number.

The invention allows Applicant to support their customers efficiently and timely with less than 600 video SLTs created. SLT stands for smallest logical topic. Videos around the smallest logical topic become the building blocks by which the invention is able to assemble a configuration specific table of contents without having to create millions of video versions. The invention allows a proper logical order for the table of contents to be maintained and updated in real time for the optimum consumer experience and comprehension. In addition, the latest content can be easily updated in real-time so users have the most current and accurate information presented at all times.

### Conclusion

The invention for which a patent application herein is submitted will revolutionize the user experience and other video content through the use of smallest logical topics and the AccuCourse tool. It will make it financially feasible to provide the “how to” user experience we all wish was true from the Ikea furniture or toys we assemble at Christmas, the lawn mower or the user manual in the glove box of your car. It is easy to understand why 7,000,000,000 (seven billion) video versions would be impractical to produce or maintain while the notion of producing 600 SLT videos seems like a more manageable solution (see FIG. 44).

### BACKGROUND PATENTS AND PUBLICATIONS

U.S. Pat. No. 8,126,200, issued Feb. 28, 2012 and entitled “Methods and Systems Employing Digital Content” discloses a user interface through which a consumer can instruct that content be delivered to a different consumer's device.

U.S. Patent application No. 2013/0091409, published Apr. 11, 2013 and entitled “Method and System for Dynamic Assembly of Multimedia Presentation Threads” discloses a survey used as input to assemble a dynamic thread generator, with thread nodes which can be traversed in a particular order.

U.S. Pat. No. 7,849,392, issued Dec. 7, 2010 and entitled “Systems and Methods for Generating Technical Documentation from Enterprise Service-Oriented Architecture Content” discloses a dynamic assembly of technical documentation.

U.S. Patent application No. 2014/0006157, published Jan. 2, 2014 and entitled “Managed Rich Media System and Method” discloses the assembly of media content which can be distributed via a web form (FIG. 5).

U.S. Pat. No. 8,548,992, issued Oct. 1, 2013 and entitled “User Interface for a Digital Content Management System” discloses a treeview control and filters to dynamically display root-level category and secondary category information.

U.S. Pat. No. 6,853,981, issued Feb. 8, 2005 and entitled “Method and System for Processing Customer Requests and Generating Associated Information correlated To Ordered Products” discloses dynamic assembly of technical information for a particular product.

U.S. Pat. No. 8,645,816, issued Feb. 4, 2014 and entitled “Customizing User Documentation” discloses a user to enter information and then configure personalized documents.

### BRIEF SUMMARY OF THE INVENTION

None of the prior art discloses the inventive concept of providing a computer implemented system and method for providing product documentation with a dynamic table of contents between two or more computer systems and the cloud.

### DEFINITIONS

The term “Customers” as used herein is understood to be companies or individuals who have purchased the inventive software in order to be able to provide their clients (also known as end-users) with media content via the inventive dynamic table of contents for one or more products.

The term “Clients” (also known as end-users) are understood to have purchased one or more products provided by Customers, and to have access to media content provided via the inventive dynamic table of contents.

The term “Admin” as used herein is understood to be a person working for a Customer who maintains the database specific to one or more products (referred to herein as a Product Group).

Authentication:

It is contemplated that a customer using the inventive program could provide at least three different types of authentication. For example, a customer like an automobile company might pay for fully paid-up access to all of its end-users and have sticker information for all options installed on a vehicle, and use a VIN number to allow an end-user to access a version of the invention which provides a customized on-line user manual which is customized to the specific model of vehicle, with all the options which are installed. All the end-user would need is the website and a VIN number. The end-user would browse to the product specific website URL provided by the Customer, enter their VIN number and the inventive program would have everything it needed to prepare the appropriate dynamic table of contents of media for the end-user.

An advantage for the automobile company (and the end-user) would be that rather than write a user manual which is generic to all the various engine options, trim lines, etc. they could provide content which was targeted at what each end-user actually purchased.

Another advantage for both the automobile customer and the end-user would be if a product recall occurred, the customer could update its product information accordingly and the updated information would be available to all customers on a going forward basis.

A second form of authentication could be provided for Customers who work through dealers and the information about a product and its various options may not filter back to the Customer. In that case, a website could be provided which would look up a product with its various options, much like Kelly's Bluebook—via a questionnaire, which would tell the program at the website the product, model and various options selected by the end-user. Once the questionnaire is completed, the dynamic table of contents of the appropriate media would be prepared for the end-user to selectively view.

A third form of authentication could be provided for an end-user who paid a fee (perhaps annually) for access to the media content. Authentication could take the form of a specific product id (such as a serial number), and the database could look up a warranty start and end date to verify the warranty is still active. The database would have the options for the product indicated. Alternatively, the program could gather the name and address of a user and look that up in the database, instead of a serial number. Again, the database would be able to look up the options for the product indicated.

Authentication could take the form of manually typing information into a webform, or a scanner could be used to scan a barcode or QR code which embodies the URL, specific product Id (which could include identifying the product and serial number).

A scanner could be used to scan a code which contains a product code, a product serial number and a url. The scanned code is passed to a server operatively connected to the scanned url using a computer connected to a network. The scanned product code and product serial number is authenticated. If authentication is passed, the server retrieves all configured components associated with the product serial number and product code from a database. In turn, the server then retrieves table of contents items related to each configured component, each table of contents item containing a table of contents entry, a level code related to its position within the table of contents and its level within the multiple levels and a url linked to a piece of multi-media content. The browser displays the retrieved table of contents in a multi-level treeview control. The end user can use the treeview control to view the entire table of contents dynamically created for their product, configured with all configured components of the product, and by clicking on a table of contents item, display the linked piece of multi-media content in the browser. Or the treeview control can be configured so that just pieces that the end user selects are displayed.

The code can be any type of machine readable code, such as a QR code or a bar code. The code can be scanned by a camera in a computer (such as a webcam built in to a laptop), or a camera app in a smart phone or a separate scanner device.

Authentication can be done by verifying that the entire range of sold serial numbers (the entire product code or id) is enabled (meaning the Customer has paid to enable the dynamically available product documentation). Or the end user can pay during a warranty period (the content is authenticated on a serial number by serial number basis, per product code).

The multi-media content can be any type of computer file which can be pointed to by a url. In a preferred embodiment the multi-media content is a video file. However, in other embodiments the multi-media file type could be, a webpage, a PDF file, a video file, an image file, any type of document file (such as word, powerpoint, or a spreadsheet), an animation file and the like, or any combination thereof. The urls can be local (stored on the server or on an external drive connected to the server), or can be stored in the cloud (google drive, amazon cloud services or the like).

Because everything is done dynamically, the end user gets a customized set of assembly instructions and operating instructions, tailored for the product with the specific optional features installed. For example, if the product is an automobile, the media files would be specific to the particular options selected by the end-user, including the appearance of the console (for example).

Compare to a car manual, which is generic across an entire platform of vehicles and is typically outmoded shortly after shipping.

In addition, because the content can be edited and maintained, the multi-media viewed is up to date and current. So if errors are corrected, the end-user would have the corrected content on a going forward basis. Or if a product recall were to occur, and procedure changes were made based on the recall—the media could be updated and made available to all end-users on a going forward basis with one simple update. It would be as if the Customer mailed out a replacement user manual, except customized to a specifically configured product with all installed options covered, and no non-selected options included to confuse the end-user.

An alternative embodiment of the invention could also provide instructions on how to unbox the product. For example, a QR code could be provided on the shipping container, which when scanned with a smartphone would take the end-user to a website with a dynamic table of contents which provided media on the proper way to take all the parts out of the box and what should be included in the box.

Further, a separate QR code could be provided on a part, which would direct the end-user to a separate website with assembly instructions (or the assembly instructions could be made available at the first website, if desired).

In addition to operating instructions for each part of the product and an overall operating manual for the product could be provided.

### BRIEF DESCRIPTION OF THE DRAWINGS

An exemplary embodiment of the invention is explained in greater detail below with reference to the figures.

FIG. 1 is a block diagram of the overall system.

FIG. 2 is an exemplary login screen.

FIG. 3 shows a failed authentication attempt.

FIG. 4 shows an exemplary main screen seen by an end user after authentication.

FIG. 5 shows an exemplary main screen, showing a snapshot of a video file in the viewing window.

FIG. 6 shows a screen for managing product group information.

FIG. 7 shows the options tab of the Add Product Group screen.

FIG. 8 shows a screen for managing terminology for a product group.

FIG. 9 shows the online viewer customization for a product group. (Template Management) FIG. 10 shows an exemplary viewer customization template for a product group.

FIG. 11 shows the Images and Videos tab of FIG. 10.

FIG. 12 shows the main screen the provider will use to manage the media content for a client and product.

FIG. 13 shows a screen for managing models.

FIG. 14 shows a screen for adding new models.

FIG. 15 shows a screen for editing an existing model.

FIG. 16 shows an exemplary screen showing the model configuration of a Nomad-LT.

FIG. 17 shows a screen for adding a new topic heading (or category).

FIG. 18 shows a screen for editing an existing topic heading.

FIG. 19 shows a screen for managing topic headings.

FIG. 20 shows a screen for adding a new sub-topic.

FIG. 21 shows a screen for editing an existing sub-topic.

FIG. 22 shows a screen for managing component information.

FIG. 23 shows a screen for adding a new component.

FIG. 24 shows a screen for editing a component.

FIG. 25 shows an exemplary screen for managing video file information for a component.

FIG. 26 shows a screen for adding a video file to the system.

FIG. 27 shows a screen for editing information about an existing video file.

FIG. 28 shows an exemplary screen for the management of variables or filters.

FIG. 29 shows a screen for adding a new variable or filter.

FIG. 30 shows a screen for editing an existing variable or filter.

FIG. 31 shows a screen for adding a new variable option or filter option.

FIG. 32 shows a screen for editing an existing variable option (or filter option).

FIG. 33-35 shows Client information.

FIG. 36-40 shows Specific configuration information.

FIG. 41 shows an example QR code.

FIG. 42 shows a sample webpage with a dynamically created table of contents.

FIG. 43 a table of the actual number of videos required, based on the number of variables and levels.

FIG. 44 shows the inventive table of contents in context.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

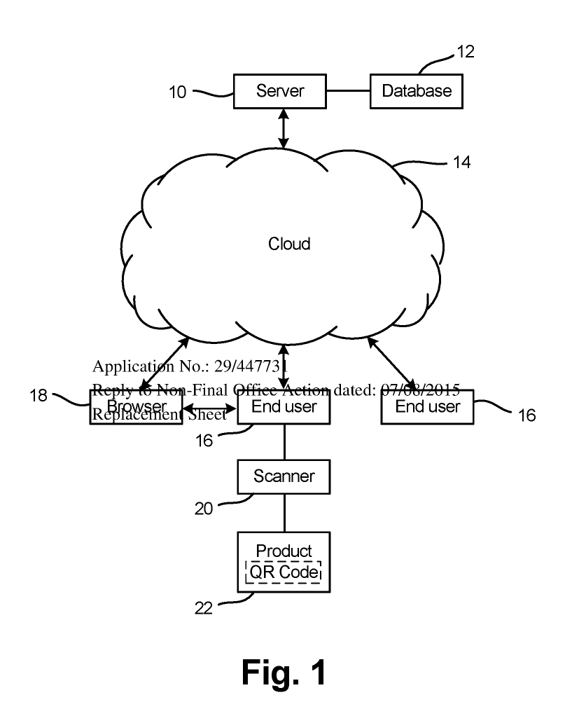

FIG. 1 is a system diagram of the inventive dynamic table of contents system. A server 10 with database 12 is connected to the cloud 14. End users 16 are connected to the cloud, each end user 16 having a browser 18 and optionally a scanning device 20 for scanning a product code 22.

Each end user may authenticate with the server to obtain access to the dynamic table of contents in a variety of ways, depending on what the customer has subscribed to or whether a customer has paid for free unlimited access for all of its clients (end users). In one scenario, a customer such as an automobile company could arrange for all of its clients (end users) to obtain free access to a user manual version of the media content, customized for the particular vehicle each end user purchased (all of the sticker options).

Alternatively, authentication can be performed using a questionnaire, which will guide the end user through selecting a product, its components and options (like the Kelly's bluebook website). This option would be useful if the customer worked through dealers and couldn't be sure of getting back all of the install options each end user purchased, to pre-load into a database against each serial number of the product. If the client has offered fully paid up access to the content, only a serial number need be entered once the product is identified, but the questionnaire can also gather user information such as name and address to authenticate, if per user authentication is in force.

Finally, a paid scenario would require that each end user may pay for access on a per serial number basis for a given product, for an annual basis or for a predetermined period of time. In this instance, if the website is for a single product, authentication can be as simple as entering a serial number to identify a particular product, with all of its components and options known to the system via the database 12, which would be entered at the point of sale.

Another optional method of authentication is to provide a QR code or bar code on each product sold, which embodies a specific configuration id (which can identify a particular product and its serial number), as well as encode a url. A smartphone can be the scanner 20 (as is well known in the art) and by taking an image of the QR code, the website at the encoded url can be accessed, the specific configuration id is passed to the website for authentication.

Authentication involves determining whether access has been provided on a fully paid up basis, or whether if per user authentication is in force, whether the specific configuration id is still under active warranty or any renewed extended warranty.

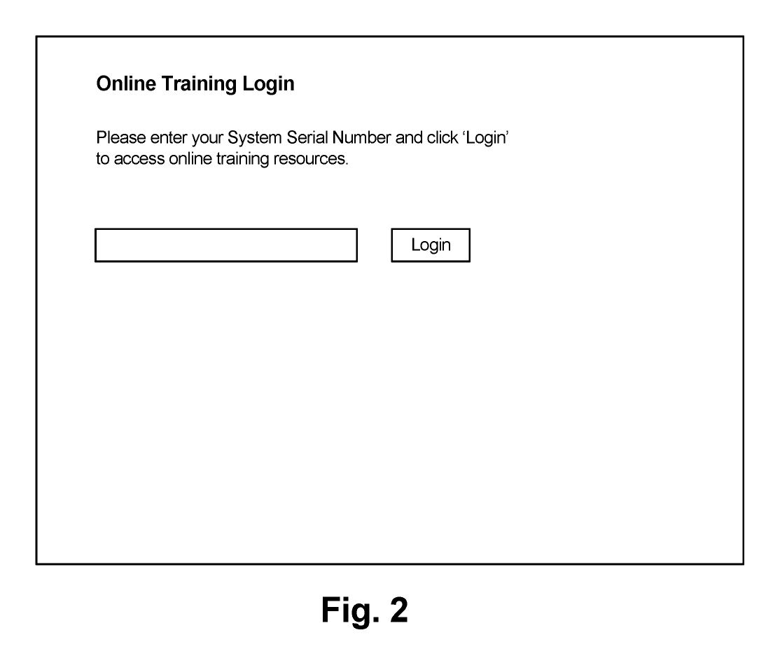

FIG. 2 shows an embodiment of a login screen in which a serial number or specific configuration id can be entered (depending on whether the website is for a single product). FIG. 2 could be a questionnaire in which the end user selects a product and enters authentication information. Or FIG. 2 could be bypassed by passing authentication information directly to the website with a QR code 22 and a scanner 20 (such as a smartphone with a web browser) or a direct link containing specific configuration id information.

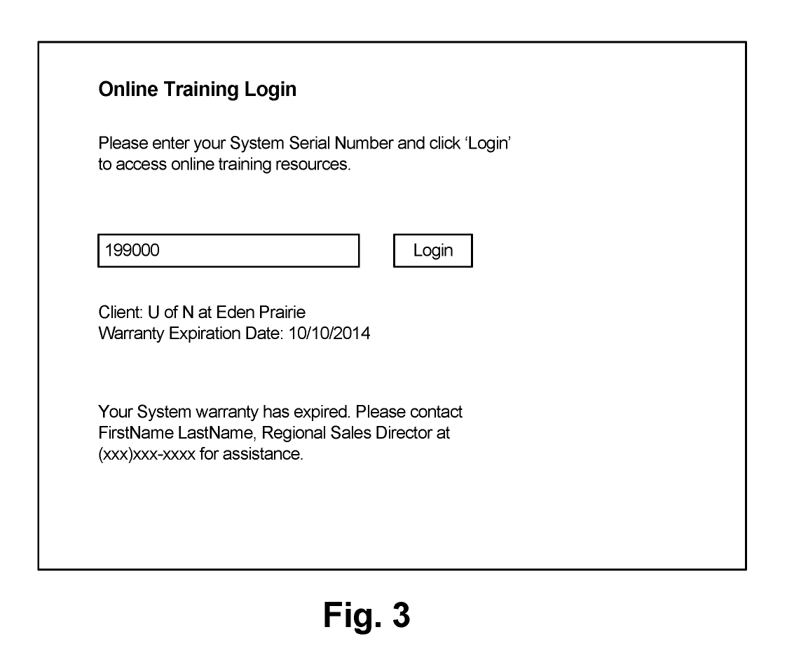

FIG. 3 shows a failed authentication screen (specific configuration id outside active warranty).

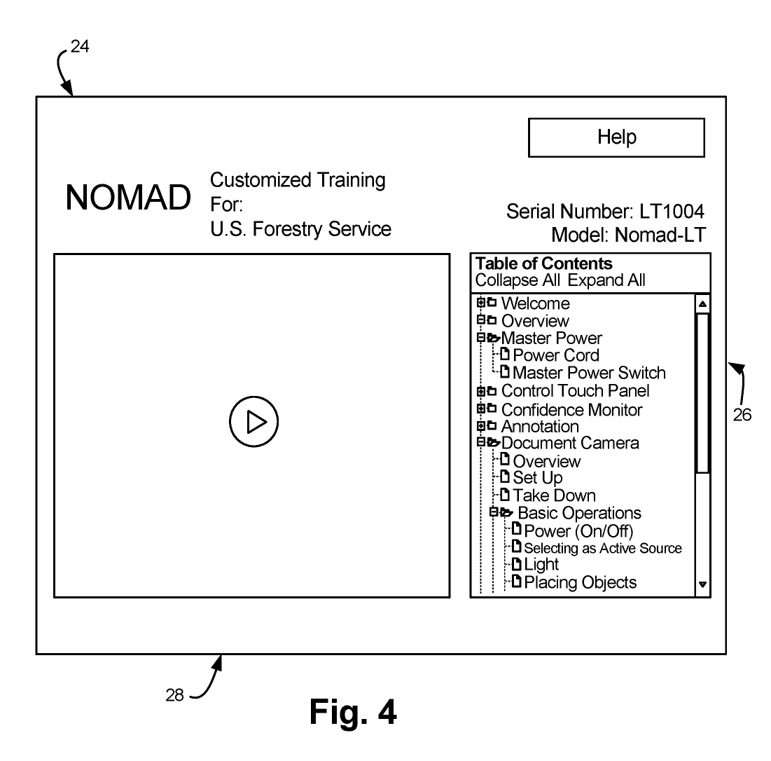

FIG. 4 shows an example of the main screen after a successful authentication. Customer information is provided in the upper left corner at 24. A treeview control with three levels is shown at 26, which allow the end user to select the content they want for a particular component and topic or sub-topic. Any desired number of nested sub-topics could be provided, but in this embodiment only three levels are provided. Once an end user has selected a topic or sub-topic from the treeview control 26, the media content (a video file in this embodiment) is displayed in a window 28.

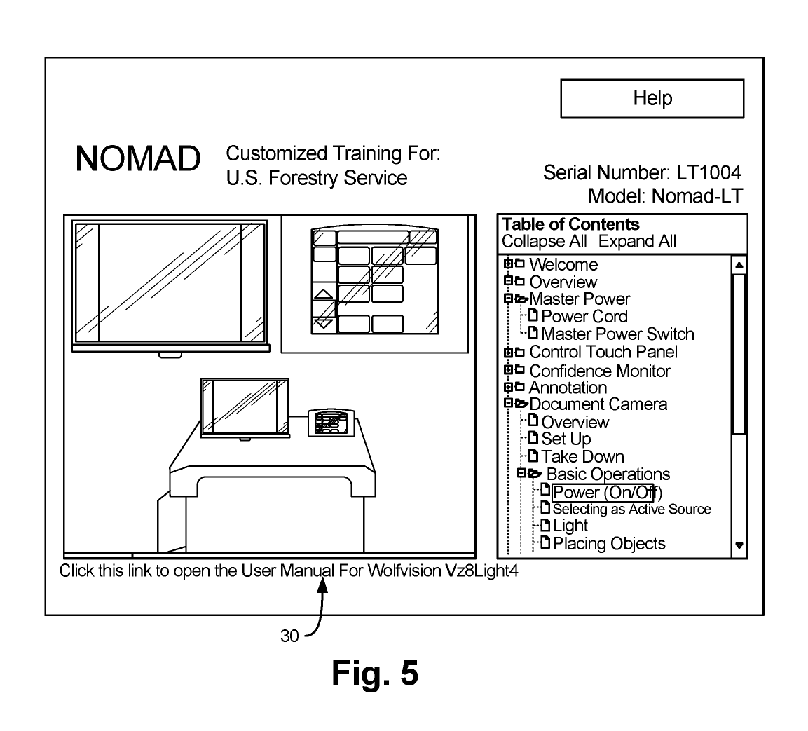

FIG. 5 shows a snapshot of a portion of the video file for the sub-topic “Power (On/Off) for the product Nomad-LT. Each video file can have an associated link 30 to a PDF or HTML page, which can be a user manual or other product documentation for the component related to the topic or sub-topic.

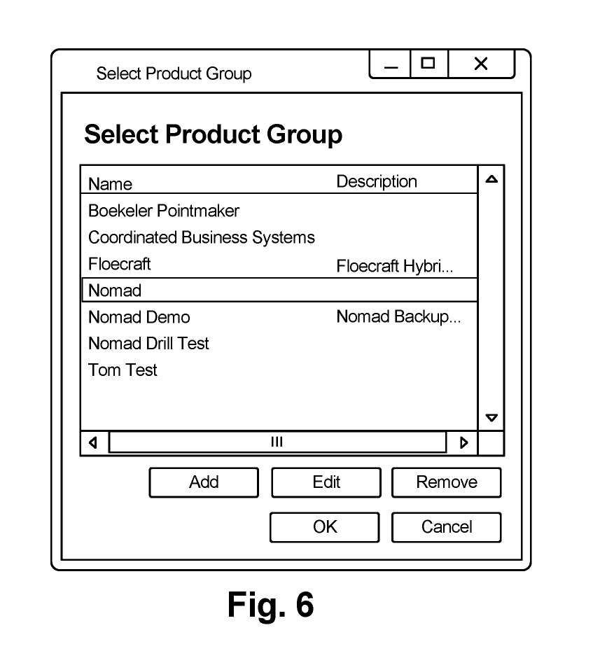

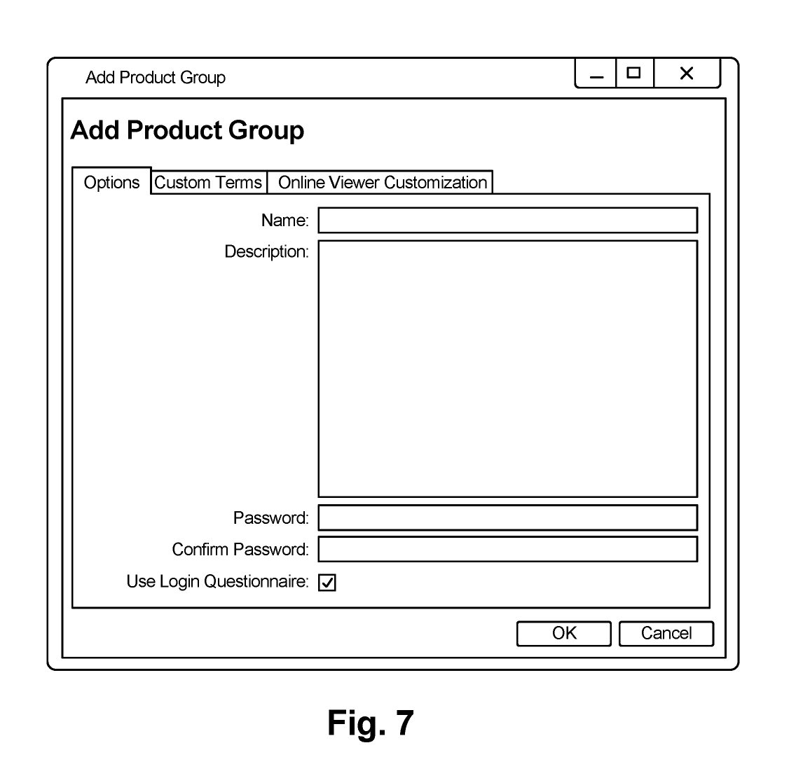

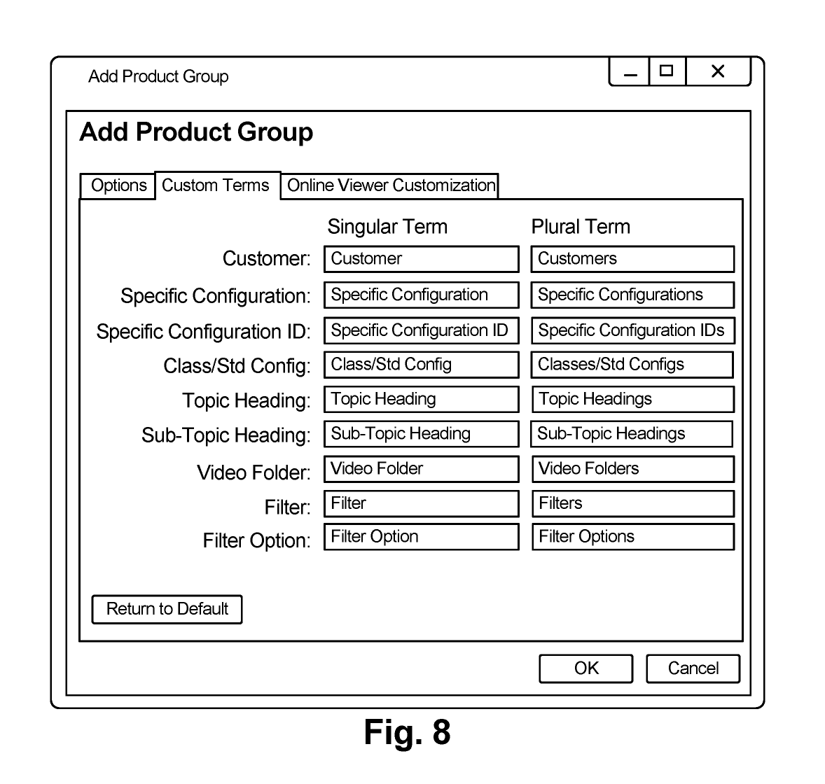

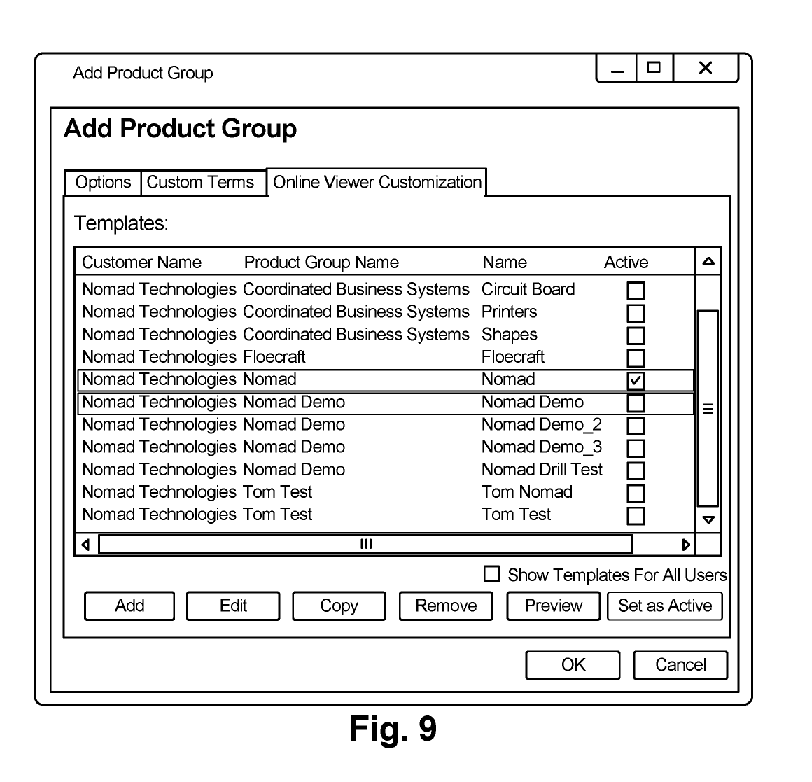

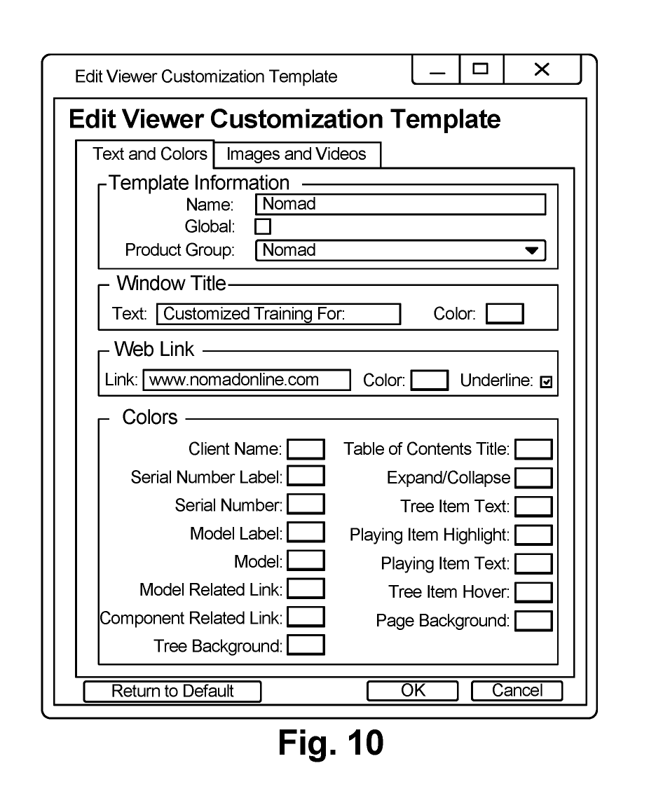

Product group information is shown at FIGS. 6-11. FIG. 6 shows a listing of available product groups. Product Group options are shown at FIG. 7. New product groups can be added at FIG. 8 (custom terminology can be used for each product group). A product group can be edited at FIG. 9. The online viewer customization can be configured for each product group, and is shown at FIG. 10. The Images and Videos tab of FIG. 10 is shown at FIG. 11. Product Groups essentially create separate databases for customers who offer multiple product lines with no overlapping user manual content. The viewer is able to be customized in order to provide an experience that is branded to that specific group of products.

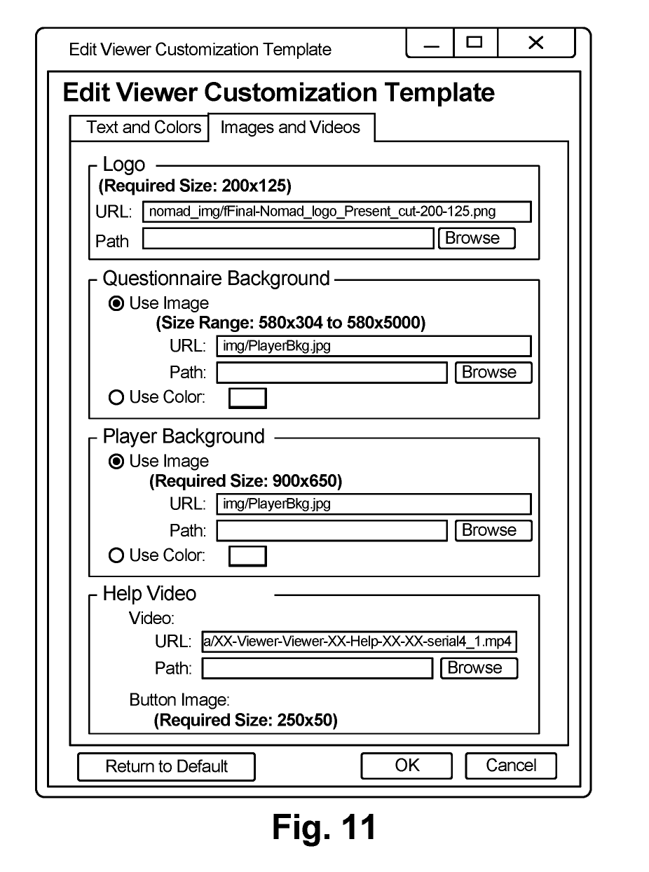

FIG. 12 shows the main screen an Admin would use to provide media content for a particular product for a client. The main menu has buttons for clients at 50 (also called customers); systems at 52 (also called specific configurations); models at 54 (also called classes/Std Configs); categories at 56 (also called topic headings); components at 58 (also called video folders); variables at 60 (also called filters), and video files at 62. A search function is provided at 64. (Everywhere “also called” is stated, that is the control name . . . the first term seen in each button is defined at FIG. 8)

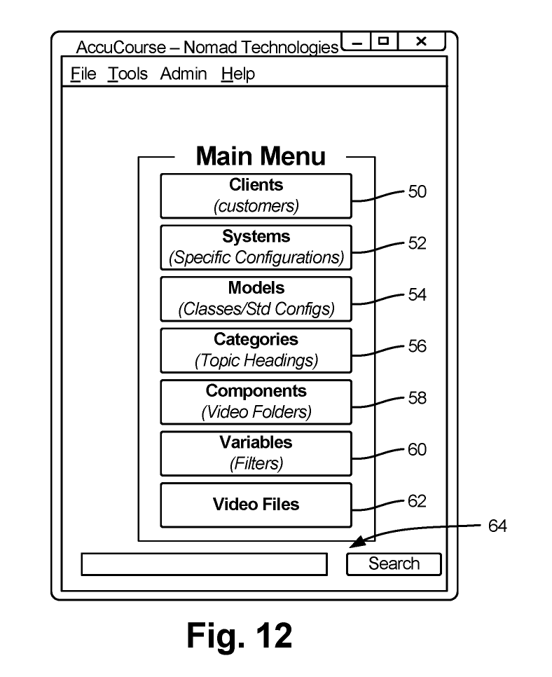

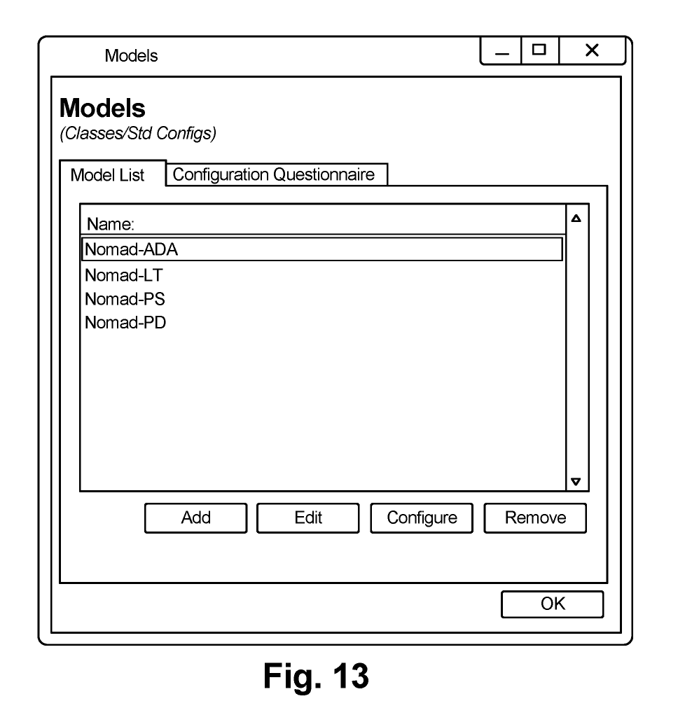

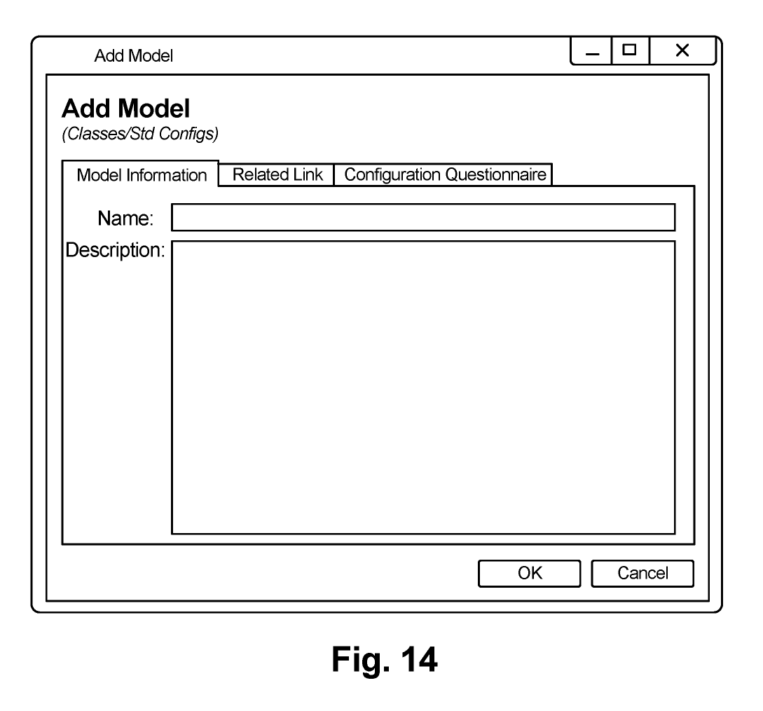

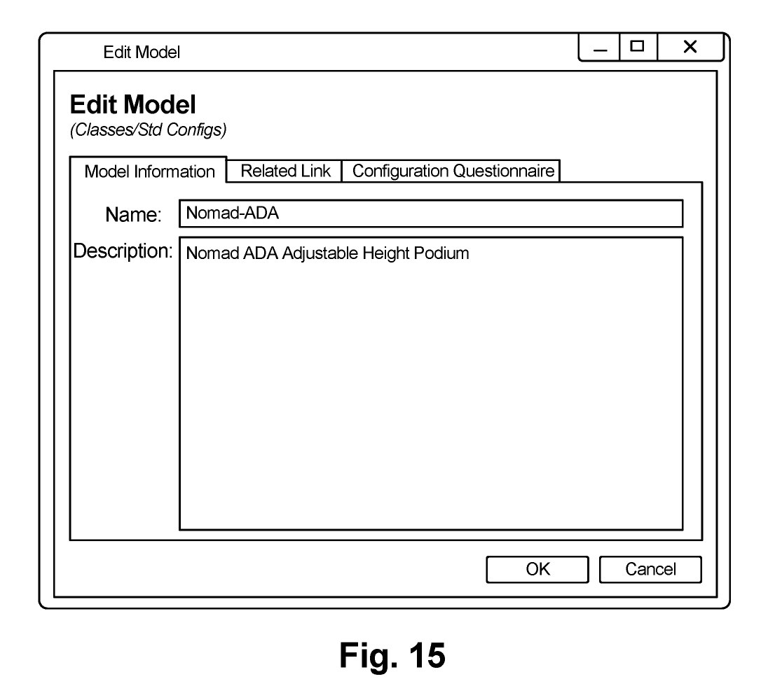

The various models and standard configurations (button 54 from FIG. 6) are shown at FIGS. 13-16. FIG. 13 shows a listing of models. New models can be added at FIG. 14. An existing model can be edited at FIG. 15. An exemplary model configuration is shown at FIG. 16, showing all available components which can be installed on the model (shown at 70). Standard installed components are listed at 72 and optional components are listed at 74. Standard components are automatically configured when a new specific configuration of the model is added to the database. Optional components are those that are available to be used in a specific configuration (either added to or in place of standard components)

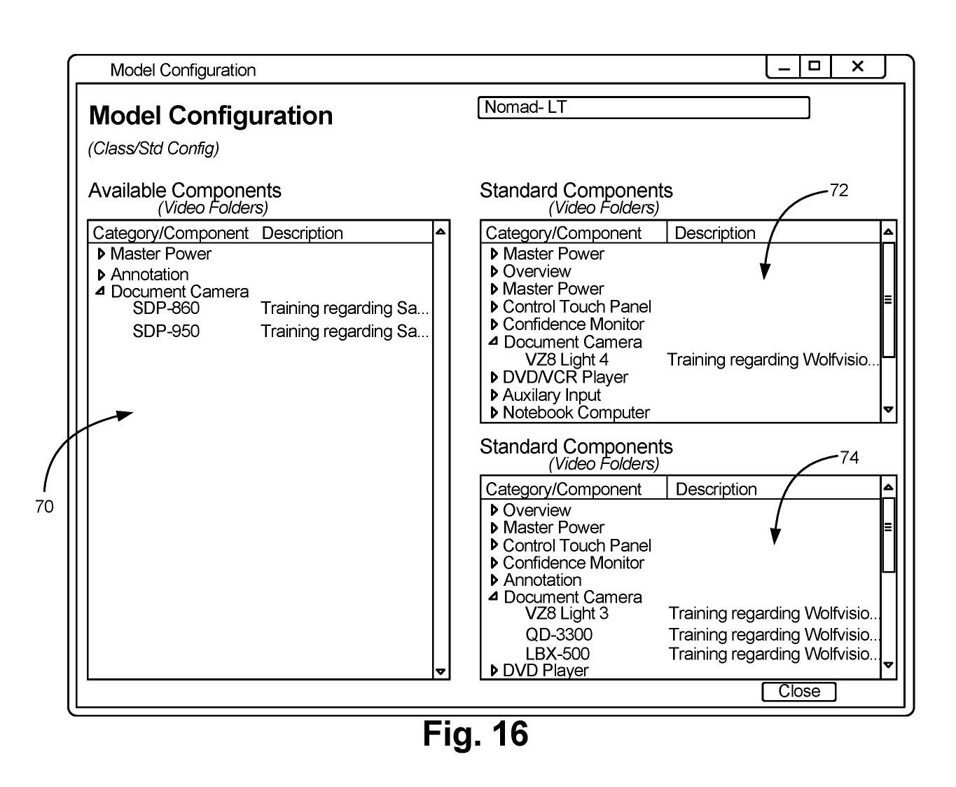

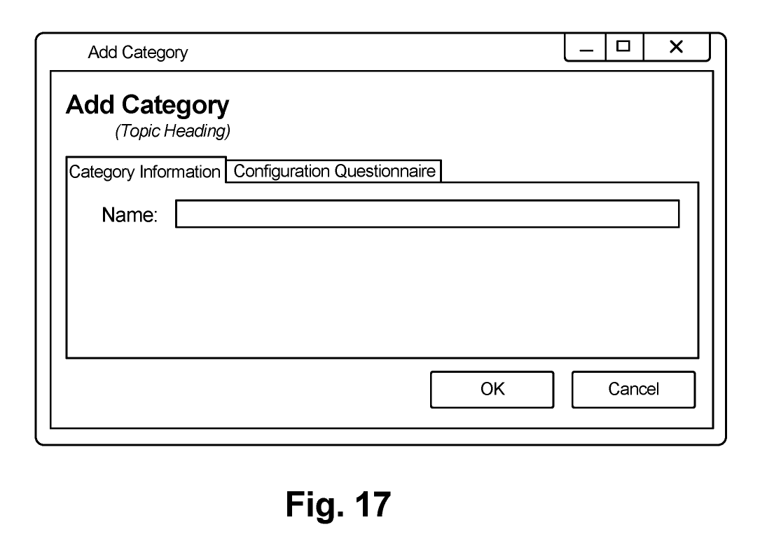

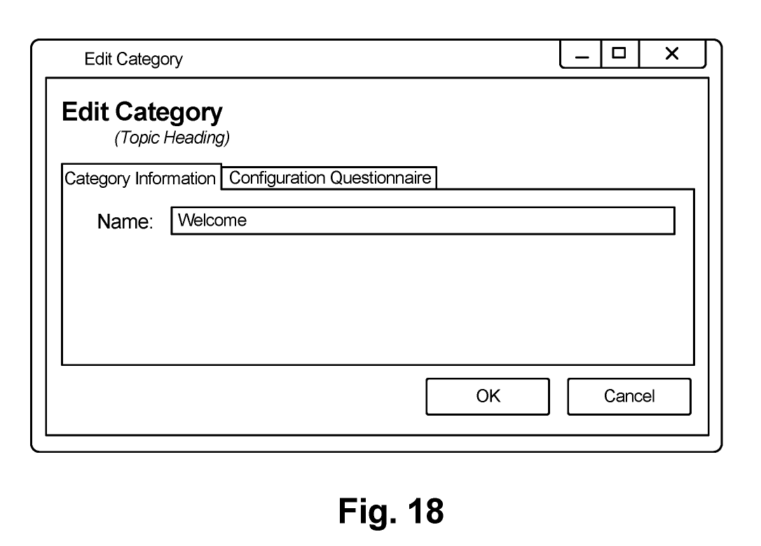

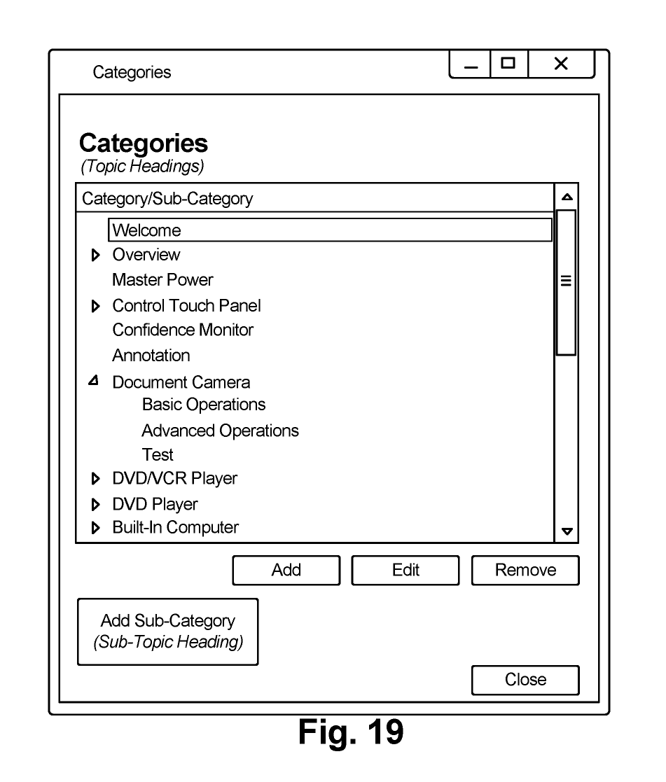

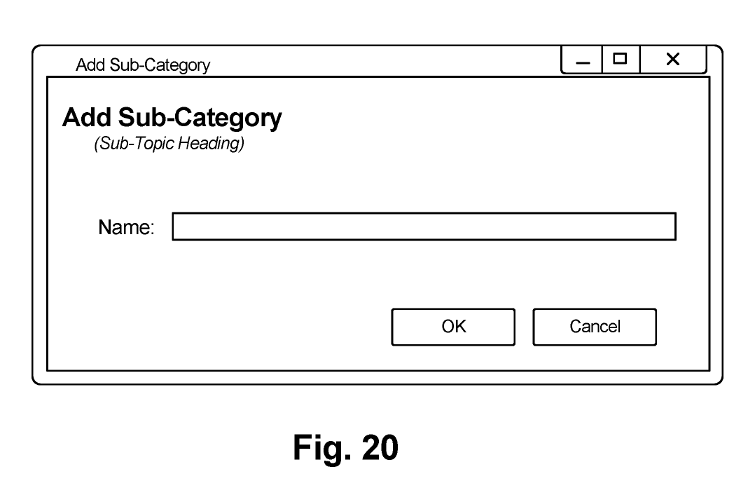

Button 56 from FIG. 12 is used for topic and sub-topic information, shown at FIGS. 17-21. A new topic heading can be added at FIG. 17 and an existing topic can be edited at FIG. 18. An exemplary topic listing is shown for a product in FIG. 19. Sub-topics can be added at FIG. 20 and edited at FIG. 21. Configuration questionnaire information can be provided per topic to allow an end user to identify particular topics they are interested in viewing based on what they purchased. Topic and Sub-topic headings are seen as folders in the viewer treeview.

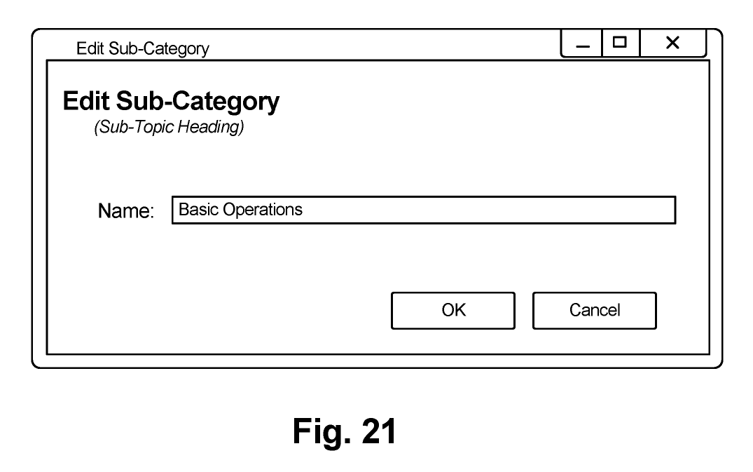

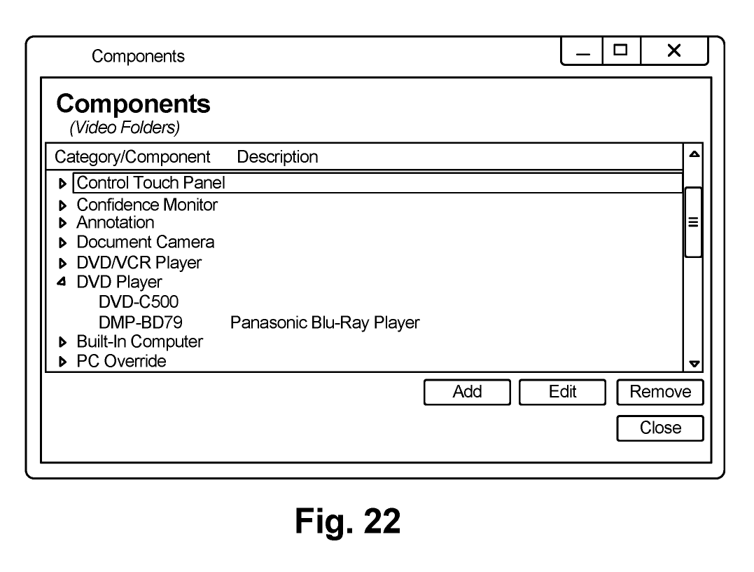

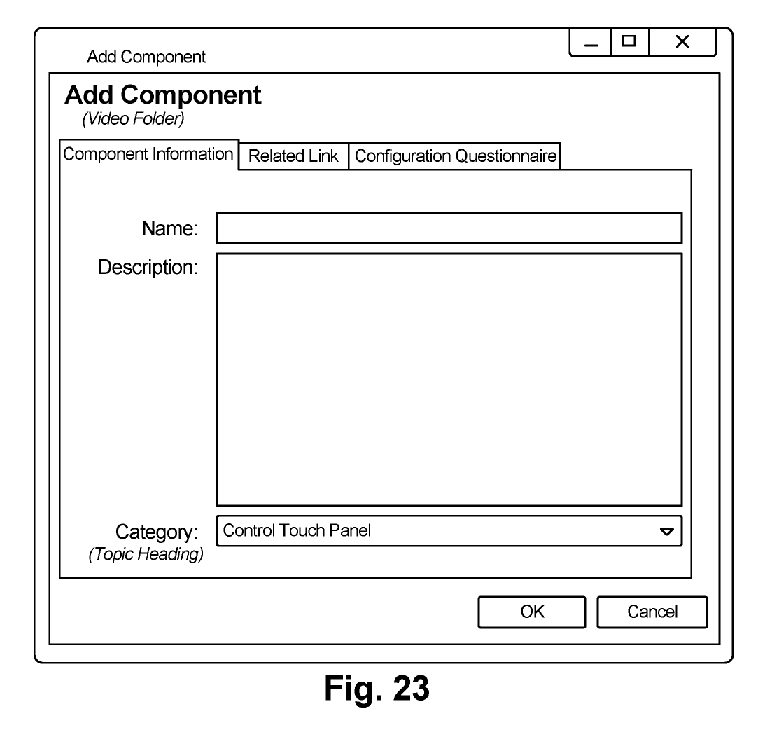

Component information (button 58 from FIG. 12) is shown at FIGS. 22-24. A listing of available components is shown at FIG. 22. New components can be added at FIG. 23 and existing components can be edited at FIG. 24. Configuration Questionnaire information can be associated with each component to allow an end user to specify which components are installed on their specific configuration. Each component must be assigned to a category. When a component is included in a specific configuration, the treeview only shows the category (or topic heading) that that component is assigned to. This allows the Admin to present a user friendly heading in the treeview while using specific, possibly internal, terminology for each component.

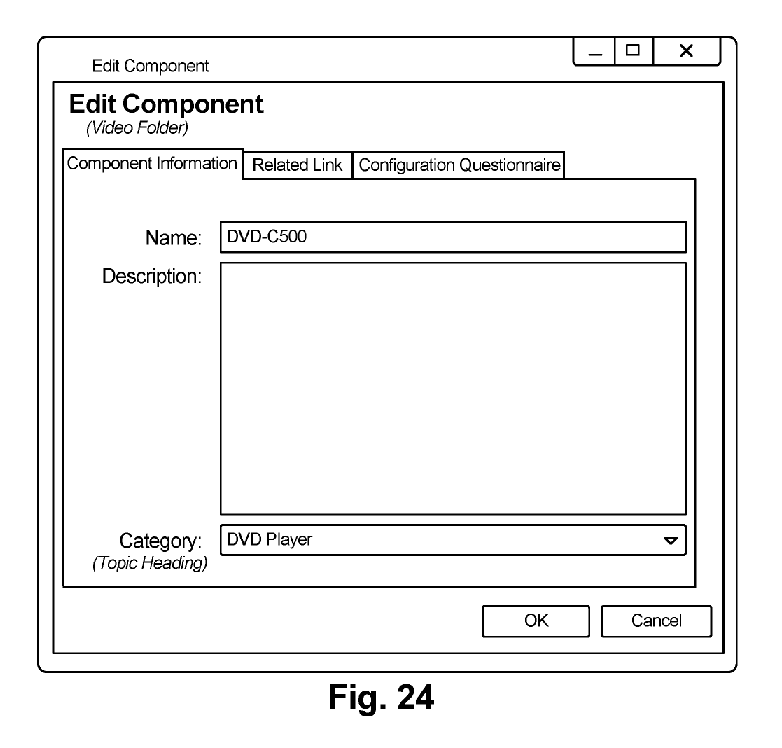

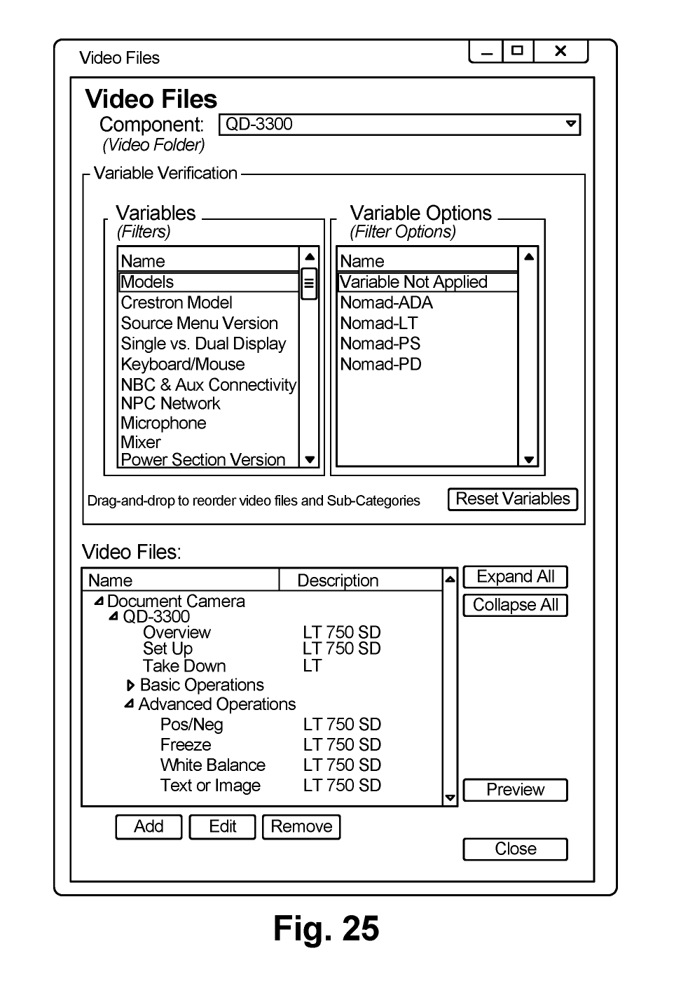

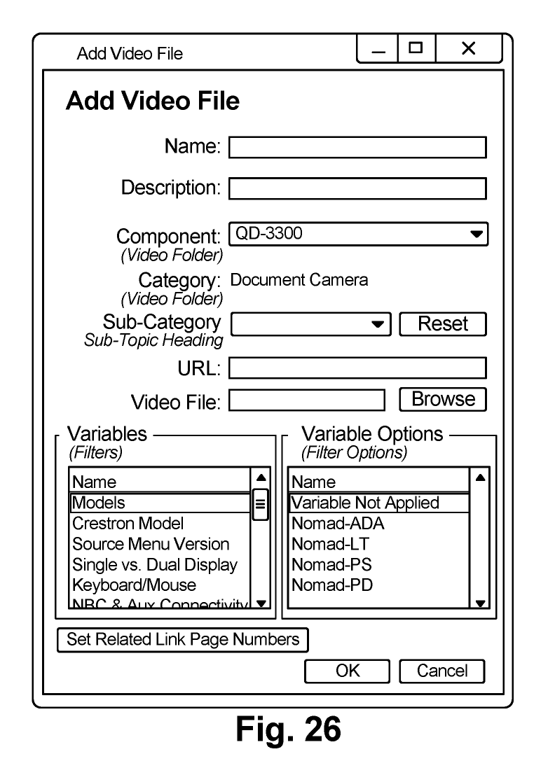

The actual media content linked to each item in the table of contents shown in the treeview control is managed at button 62 of FIG. 12, shown at FIGS. 25-27. An exemplary screen for video files for component QD-3300 is shown at FIG. 25. New video files can be added at FIG. 26 and information about an existing video file can be edited at FIG. 27. The Name field of each video file is what shows up in the treeview as the link to be clicked to present that item.

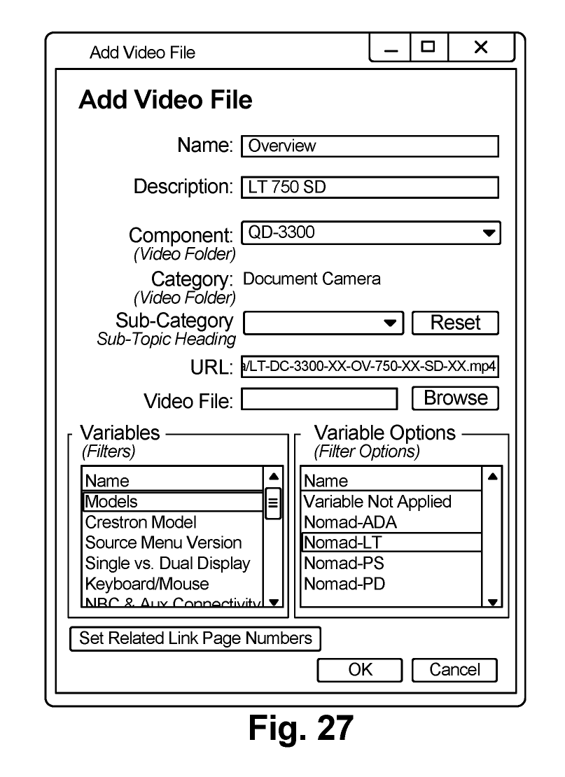

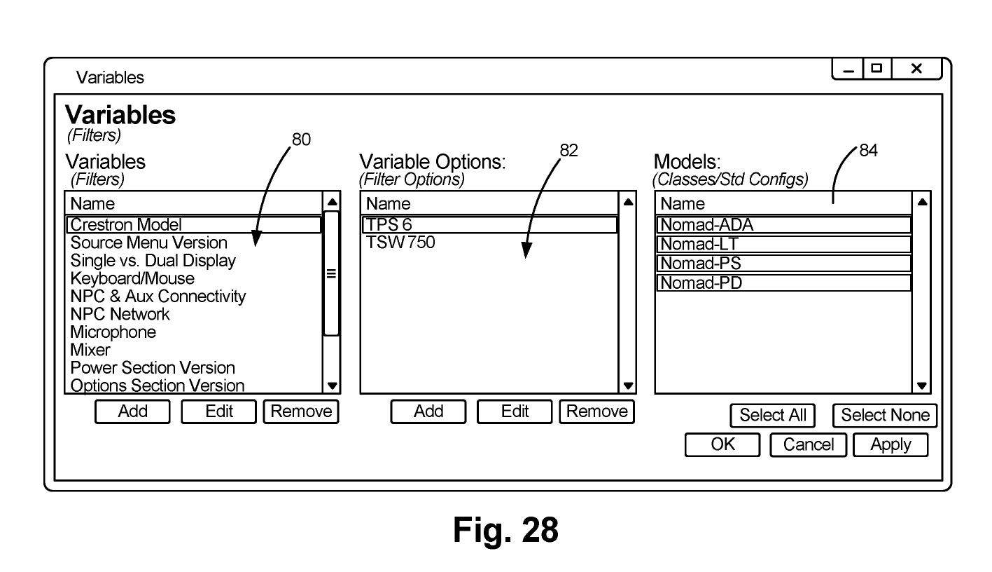

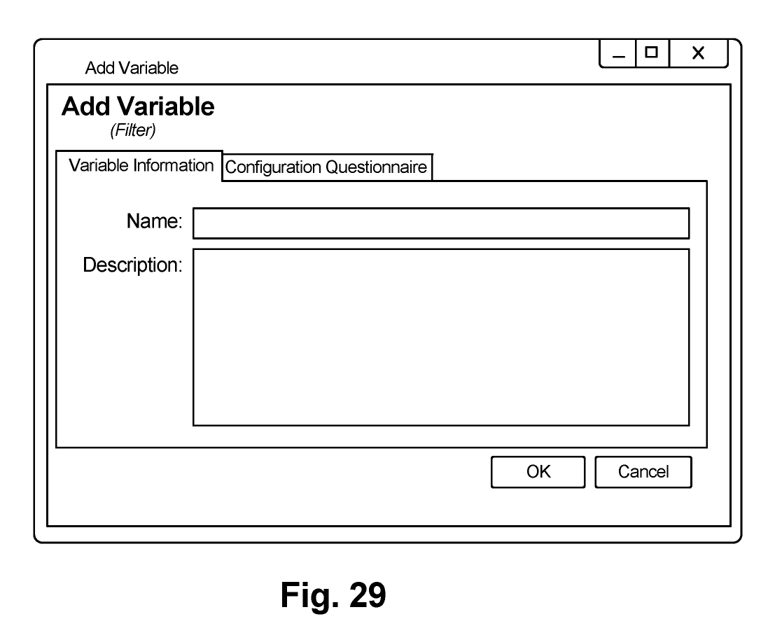

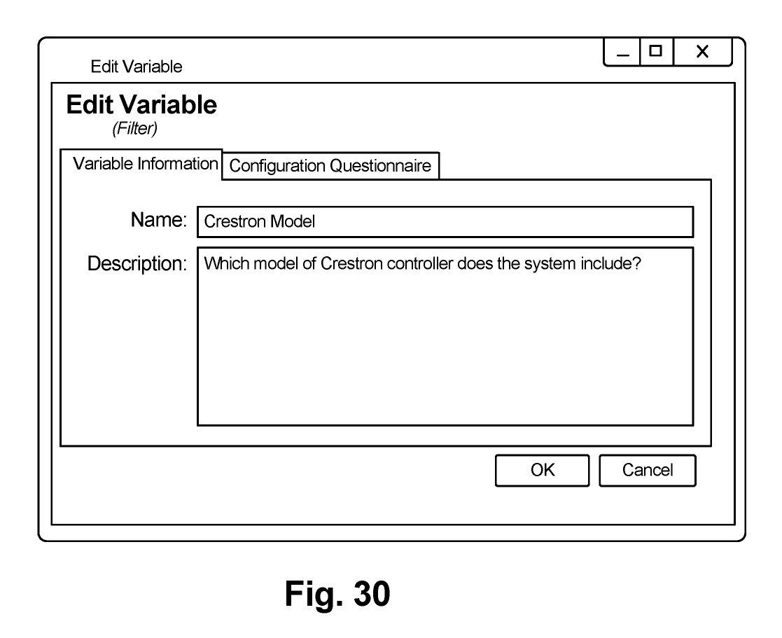

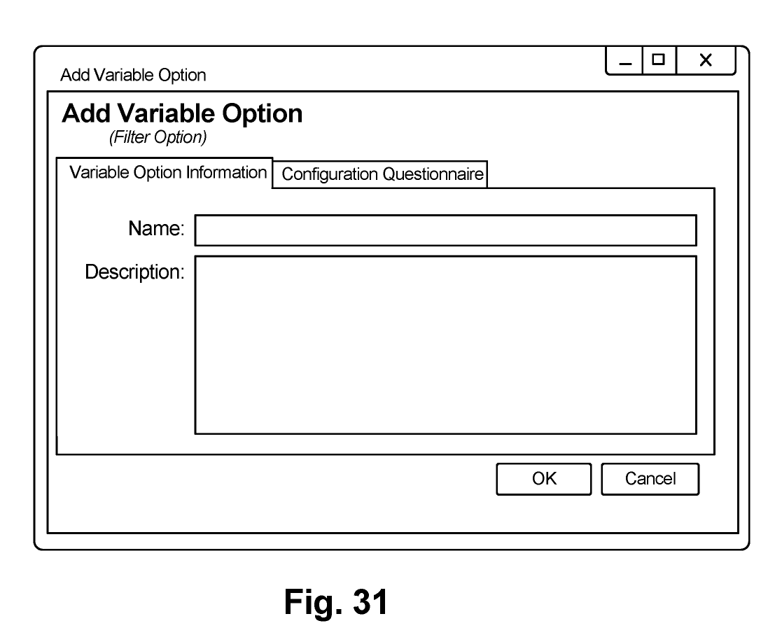

Button 60 from FIG. 12 is related to variable or filter information, shown at FIGS. 28-32. FIG. 28 shows an exemplary variable screen showing the variables (shown at 80), variable options (shown at 82) and models. New variables (filters) can be added at FIG. 29, existing variables can be edited at FIG. 30, new variable options can be added at FIG. 31 and existing variable options can be edited at FIG. 32. Variables (filters) can be applied to specific configurations and Video files. When the filter data of a video file matches that of a specific configuration the video file will be presented in the treeview. All video files with non-matching filter data will be excluded.

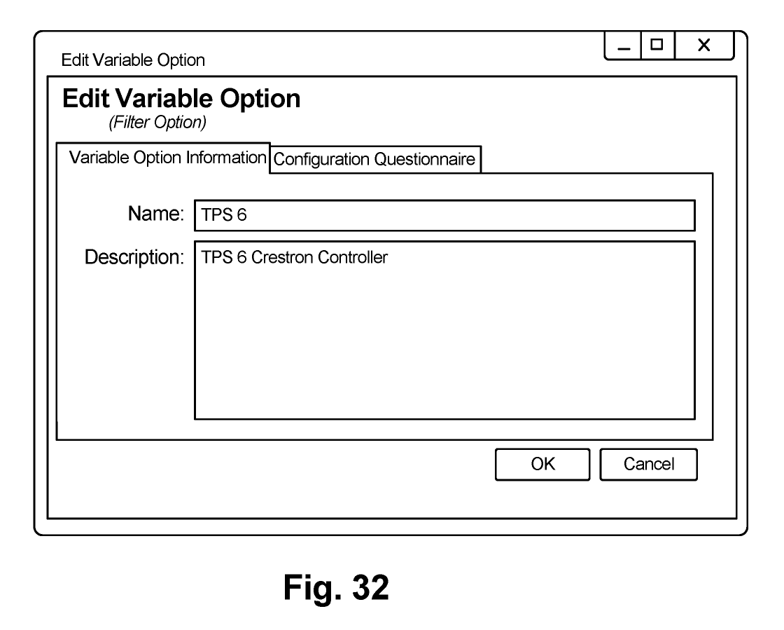

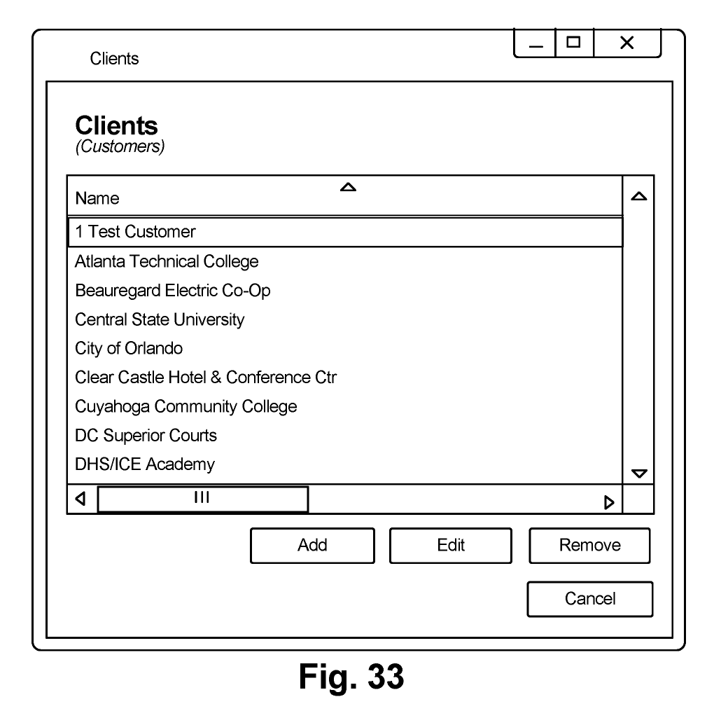

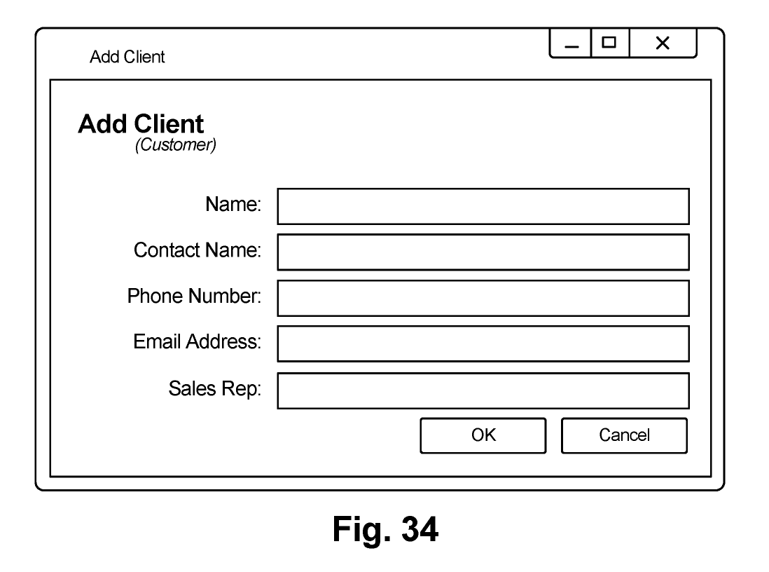

Client information is shown in FIGS. 33-35. Once clients at 50 is clicked, a listing of clients is shown (see FIG. 33). New clients can be added at FIG. 34 and existing clients can be edited at FIG. 35. FIG. 35 also allows specific configurations to be entered, each specific configuration having a specific configuration id and having a warranty start and end date.

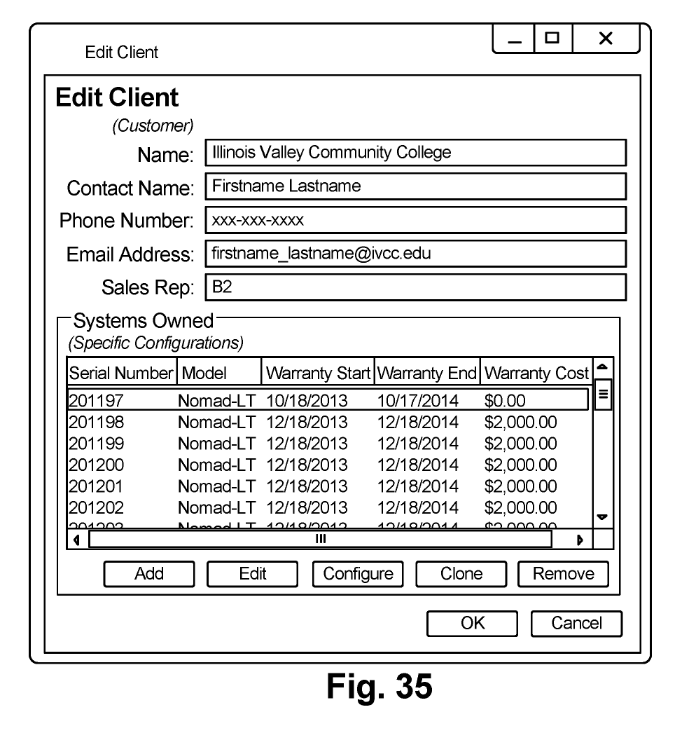

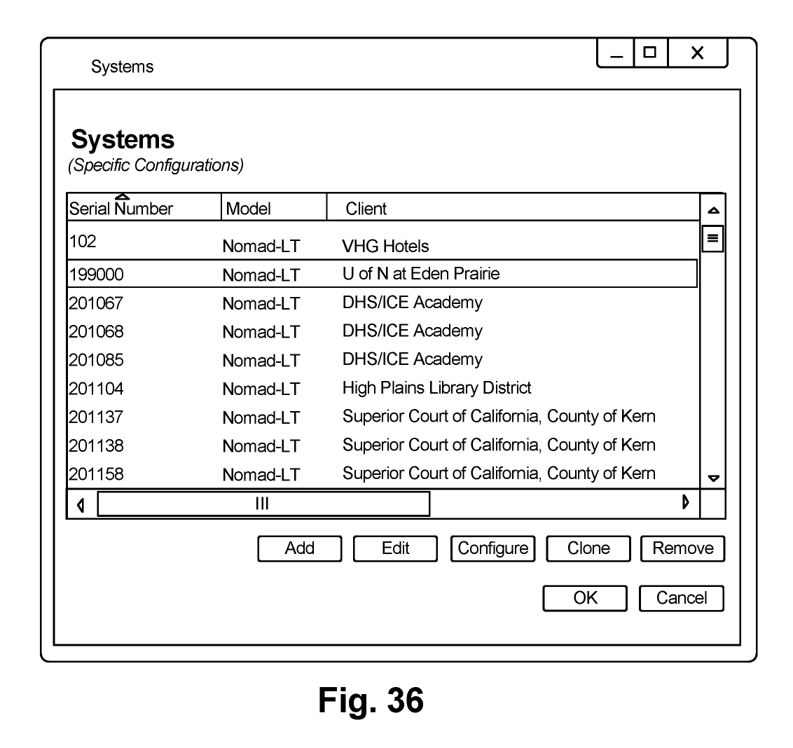

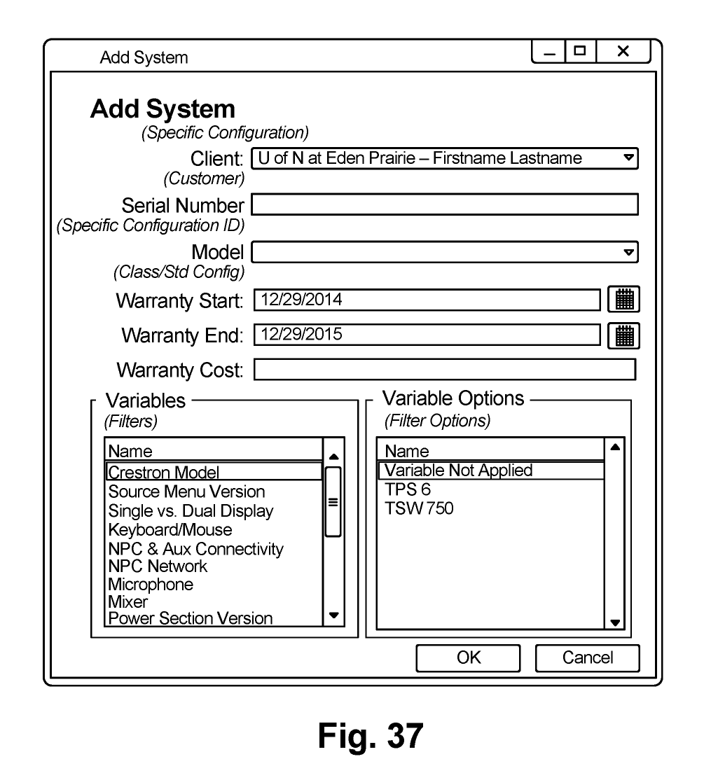

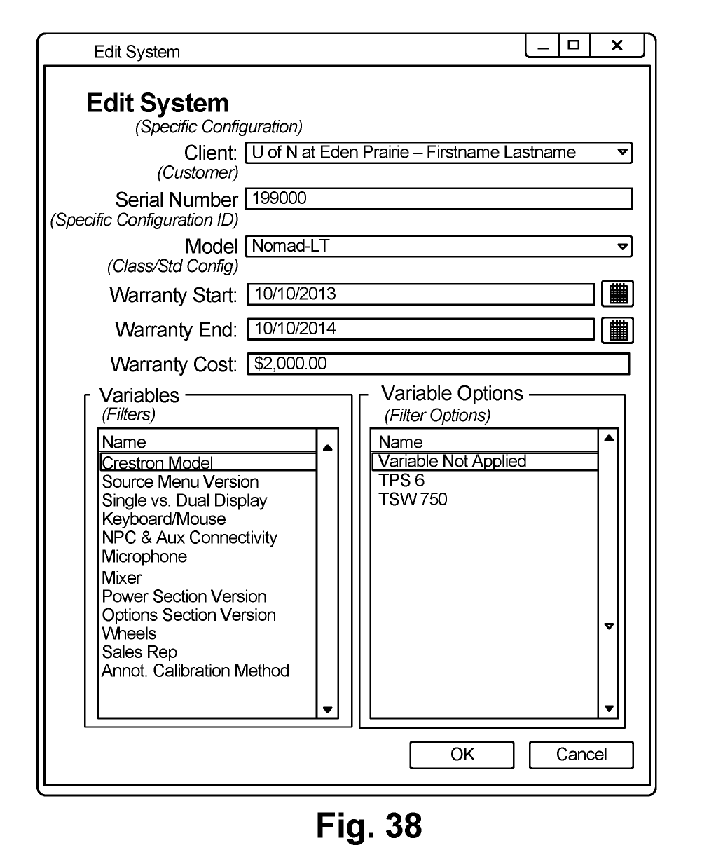

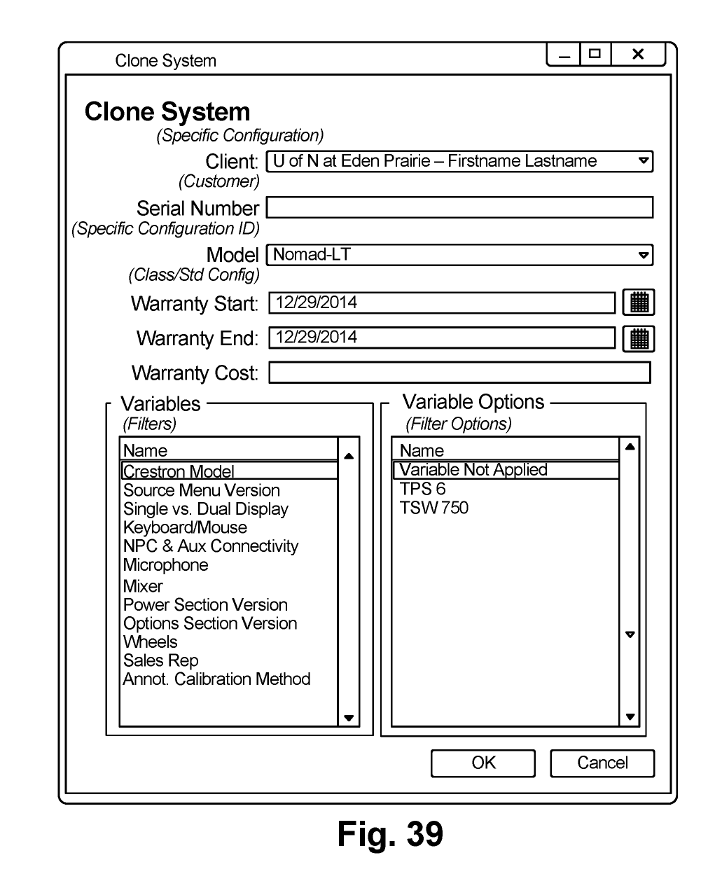

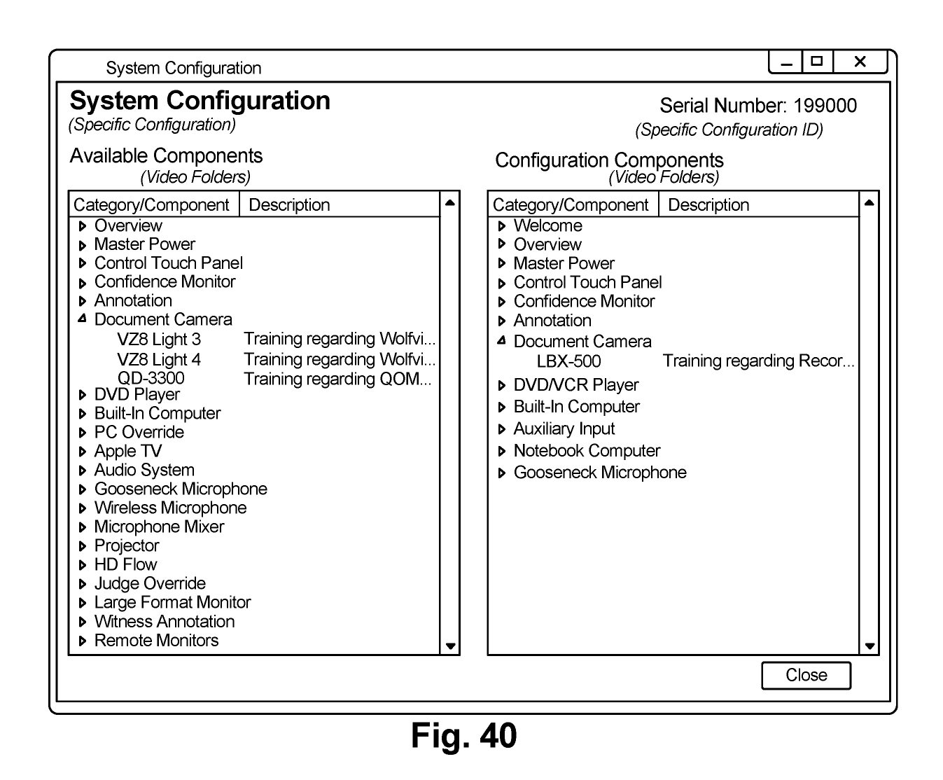

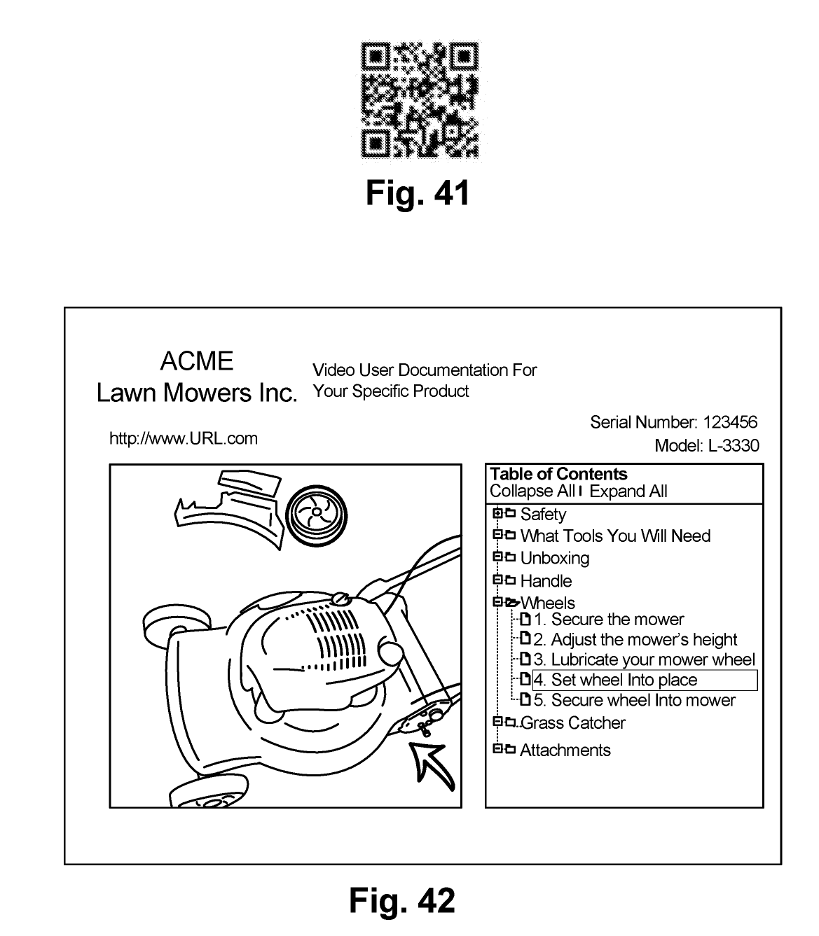

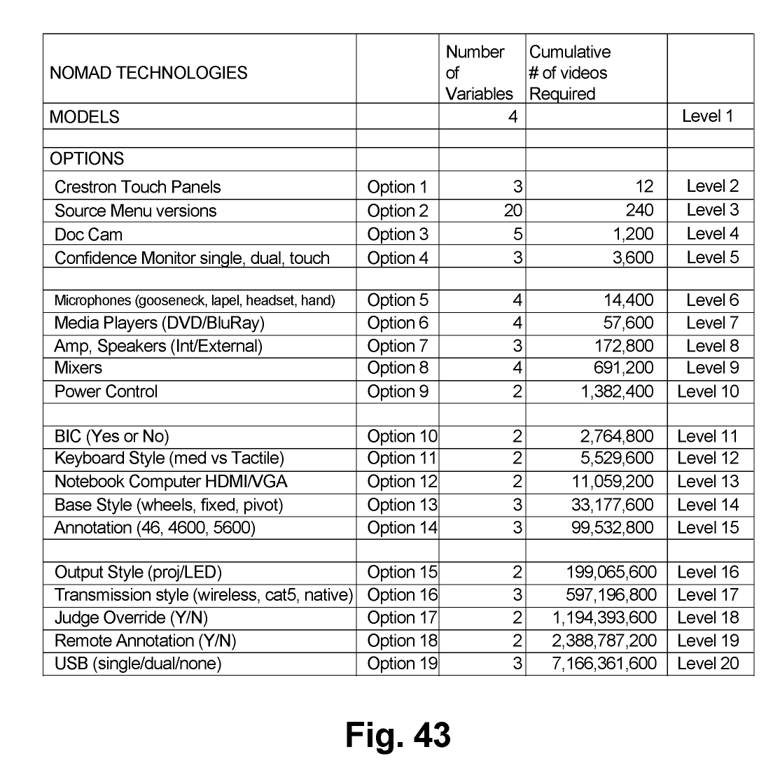

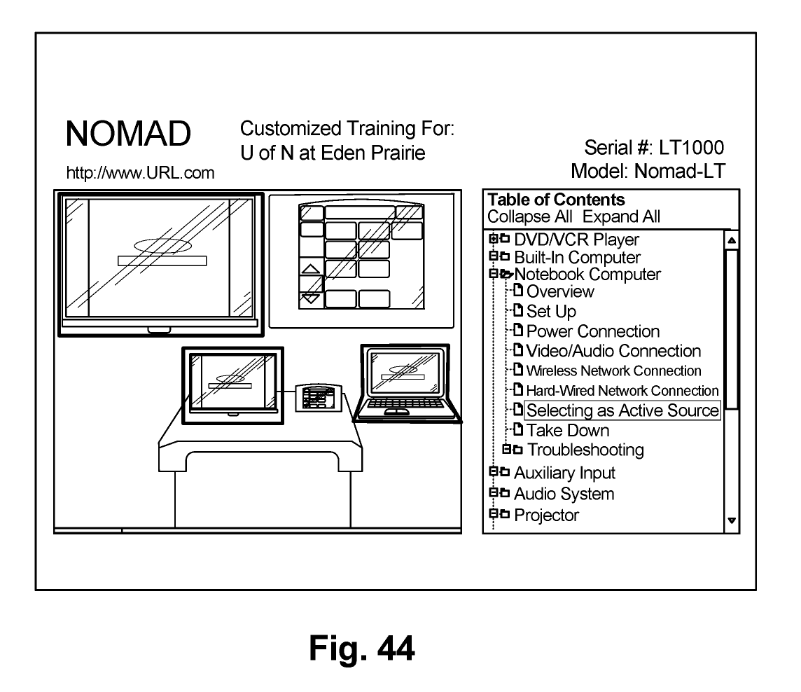

Specific configuration information is shown in FIGS. 36-40. FIG. 36 shows a listing of each serial number, and its associated product model and client. A specific configuration can be added at FIG. 37, edited at FIG. 38, cloned (for ease of adding similar configurations) at FIG. 39. An exemplary specific configuration is shown at FIG. 40, showing the available components (the universe of what could be installed on a particular product sold to an end user) and the configured components (what is actually installed on a particular product sold to an end user).

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A computer implemented method for providing product documentation with a dynamic table of contents between two or more computer systems and the cloud, the computer implemented method comprising:
authentication of a request for accessing a dynamic table of contents, the authentication selected from the group consisting of entering a specific configuration id, answering a questionnaire and scanning a code which contains a specific configuration id, a url with a scanning device, clicking on a link and providing a direct link;
retrieving all configured components associated with the specific configuration id from a database;
retrieving table of contents items related to each configured component, each table of contents item containing a table of contents entry, a level code related to its position within the table of contents and its level within the multiple levels and a url linked to a piece of multi-media content;
displaying the retrieved table of contents in a multi-level treeview control in the browser,
whereby an end user can use the treeview control to view the entire table of contents dynamically created for their product, configured with all configured components of the product, and by clicking on a table of contents item, display the linked piece of multi-media content in the browser.

2. The computer implemented method of claim 1 wherein the code is selected from the group consisting of a QR code and a bar code.

3. The computer implemented method of claim 1 wherein the scanner is a camera containing smart phone.

4. The computer implemented method of claim 1 wherein the scanner is a camera containing computer.

5. The computer implemented method of claim 1 wherein authentication is accomplished by verifying that the scanned product code is indicated as enabled in the database.

6. The computer implemented method of claim 5 wherein the scanned serial number is indicated as enabled in the database.

7. The computer implemented method of claim 1 wherein the piece of multi-media content is selected from the group consisting of a webpage, a PDF file, a video file, a document file and an image file.

8. The computer implemented method of claim 1 wherein the multi-media content is stored in the server.

9. The computer implemented method of claim 1 wherein the multi-media content is stored in the cloud.

10. The computer implemented method of claim 1 wherein the product documentation comprises the assembly instructions and the scanned code is imprinted on the packaging the product is shipped in.

11. The computer implemented method of claim 1 wherein the product documentation comprises the product operating instructions and the scanned code is imprinted on the product itself.

12. A system for providing product documentation with a dynamic table of contents between two or more computer systems and the cloud, the system comprising:
a configuration id with a product;
a server operatively connected to the computer system via a browser, the browser passing the configuration id to the server for authentication;
the server retrieving all configured components associated with the configuration id from a database;
the server retrieving table of contents items related to each configured component, each table of contents item containing a table of contents entry, a level code related to its position within the table of contents and its level within the multiple levels and a url linked to a piece of multi-media content;
the browser displaying the retrieved table of contents in a multi-level treeview control,
whereby an end user can use the treeview control to view the entire table of contents dynamically created for their product, configured with all configured components of the product, and by clicking on a table of contents item, display the linked piece of multi-media content in the browser.

13. The computer implemented method of claim 12 wherein the code is selected from the group consisting of a QR code and a bar code.

14. The computer implemented method of claim 12 wherein the scanner is a camera containing smart phone.

15. The computer implemented method of claim 12 wherein the scanner is a camera containing computer.

16. The computer implemented method of claim 12 wherein authentication is accomplished by verifying that the scanned product code is indicated as enabled in the database.

17. The computer implemented method of claim 16 wherein the scanned serial number is indicated as enabled in the database.

18. The computer implemented method of claim 12 wherein the piece of multi-media content is selected from the group consisting of a webpage, a PDF file, a video file, a document file and an image file.

19. The computer implemented method of claim 12 wherein the multi-media content is stored in the server.

20. The computer implemented method of claim 12 wherein the multi-media content is stored in the cloud.

21. The computer implemented method of claim 12 wherein the product documentation comprises the assembly instructions and the scanned code is imprinted on the packaging the product is shipped in.

22. The computer implemented method of claim 12 wherein the product documentation comprises the product operating instructions and the scanned code is imprinted on the product itself.
